(19) United States
(12) Patent Application Publication
(10) Pub. No.: US 2026/0019297 A1
(43) Pub. Date: Jan. 15, 2026

(54) Semiconductor Device and Communication System

(71) Applicant: ROHM CO., LTD., KYOTO (JP)

(72) Inventor: Kei NAGAO, KYOTO (JP)

(21) Appl. No.: 19/258,406

(22) Filed: Jul. 2, 2025

(30) Foreign Application Priority Data
Jul. 12, 2024 (JP) 2024-112360

(51) Int. Cl. H04L 12/40

(52) U.S. Cl. CPC H04L 12/40058

(57) ABSTRACT

A semiconductor device comprises a receiving section configured to receive a reception data as serial data from an outside, and an anomaly check section configured to check for a presence or absence of an anomaly, whose cause can be identified, by checking the reception data.

### TECHNICAL FIELD

The present disclosure relates to a semiconductor device.

### BACKGROUND

Semiconductor devices comprising serial communication functions are used in various applications.

Furthermore, an example of circuit technology related to serial communication is disclosed in Patent Document 1.

### PRIOR ART DOCUMENT

### Patent Document

[Patent document 1] Japan Patent Publication No. 2017-224946.

### BRIEF DESCRIPTION OF THE DRAWINGS

FIG. 1 is a diagram showing a configuration of a communication system according to an example of embodiments of the present disclosure.

FIG. 2 is a diagram showing a configuration of a communication system according to another example of embodiments of the present disclosure.

FIG. 3 is a diagram showing a format of reception data RX during a Write process.

FIG. 4 is a diagram showing a configuration according to communication control in a semiconductor device.

FIG. 5 is a diagram showing a reception data RX and a transmission data TX during a Write process or a Read process.

FIG. 6 is a diagram showing a flowchart related to an anomaly check process according to a first embodiment.

FIG. 7A is a diagram showing a frame of reception data RX in a case of normal operation.

FIG. 7B is a diagram showing a frame of reception data RX in a case of anomalous operation.

FIG. 7C is a diagram showing a frame of reception data RX in a case of anomalous operation.

FIG. 8A is a diagram showing a normal state during a Read process in the communication system shown in FIG. 1.

FIG. 8B is a diagram showing a normal state during a Read process in the communication system shown in FIG. 2.

FIG. 8C is a diagram showing an anomalous state during a Read process in the communication system shown in FIG. 2.

FIG. 9 is a diagram showing a configuration of a CAN transceiver.

FIG. 10 is a flowchart related to an anomaly check according to a third embodiment.

FIG. 11 is a diagram showing a synchronization frame SYN in a normal or anomalous case.

FIG. 12 is a flowchart related to an anomaly check according to a fourth embodiment.

FIG. 13 is a diagram showing a synchronization frame SYN.

FIG. 14 is an external view showing an example of a vehicle.

### DETAILED DESCRIPTION OF THE EMBODIMENTS

Hereinafter, exemplary embodiments of the present disclosure are illustrated with reference to figures.

### 1. COMMUNICATION SYSTEM

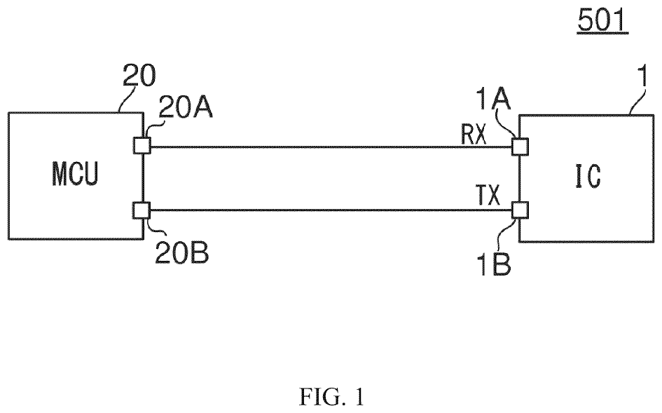

FIG. 1 is a diagram showing a configuration of a communication system 501 according to an example of embodiments of the present disclosure. The communication system 501 comprises an MCU (Micro Controller section) 20 and a semiconductor device 1. Communication between the MCU 20 and the semiconductor device 1 is conducted using UART (Universal Asynchronous Receiver/Transmitter) as a communication method. UART is a format for exchanging serial data between two devices. In UART, bidirectional communication is conducted over two lines between a transmitting side and a receiving side.

The semiconductor device 1 is an IC (Integrated Circuit) in which circuits for specific functions are integrated, and is configured, for example, as an LED (Light Emitting Diode) driver IC.

An output terminal 20A of the MCU 20 is connected to an RX (Receive Data Input) terminal 1A of the semiconductor device 1. An input terminal 20B of the MCU 20 is connected to a TX (Transmit Data Output) terminal 1B of the semiconductor device 1. The RX terminal 1A receives a reception data RX output from the output terminal 20A. A transmission data TX transmitted from the TX terminal 1B is input to the input terminal 20B.

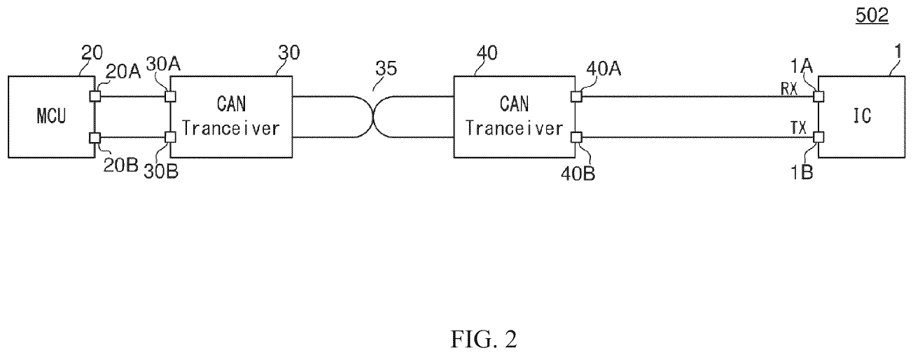

FIG. 2 is a diagram showing a configuration of a communication system 502 according to another example of embodiments of the present disclosure. The communication system 502 comprises an MCU 20, a CAN (Controller Area Network) transceiver 30, a CAN transceiver 40, and a semiconductor device 1.

Communication between the MCU 20 and the CAN transceiver 30 is conducted using UART as a communication method. Communication between the CAN transceivers 30, 40 is conducted using a CAN bus 35. CAN is a serial communication protocol standardized by international standards such as ISO 11898. Communication between the CAN transceiver 40 and the semiconductor device 1 is conducted using UART.

The CAN transceiver 30 comprises a TXD (Transmit Data Input) terminal 30A and an RXD (Receive Data Output) terminal 30B. The TXD terminal 30A is connected to an output terminal 20A of the MCU 20. The RXD terminal 30B is connected to an input terminal 20B of the MCU 20. The CAN transceiver 30 outputs data input to the TXD terminal 30A to the CAN bus 35 and outputs data input from the CAN bus 35 from the RXD terminal 30B.

The CAN transceiver 40 comprises an RXD terminal 40A and a TXD terminal 40B. The CAN transceiver 40 outputs data input to the TXD terminal 40B to the CAN bus 35 and outputs data input from the CAN bus 35 from the RXD terminal 40A.

The RXD terminal 40A is connected to an RX terminal 1A of the semiconductor device 1. The TXD terminal 40B is connected to a TX terminal 1B of the semiconductor device 1. The reception data RX output from the RXD terminal 40A is input to the RX terminal 1A. The transmission data TX output from the TX terminal 1B is input to the TXD terminal 40B.

### 2. WRITE/READ PROCESS

Next, a Write process and a Read process for the semiconductor device 1 are illustrated. Write refers to a process of writing data to the semiconductor device 1, and Read refers to a process of reading data from the semiconductor device 1.

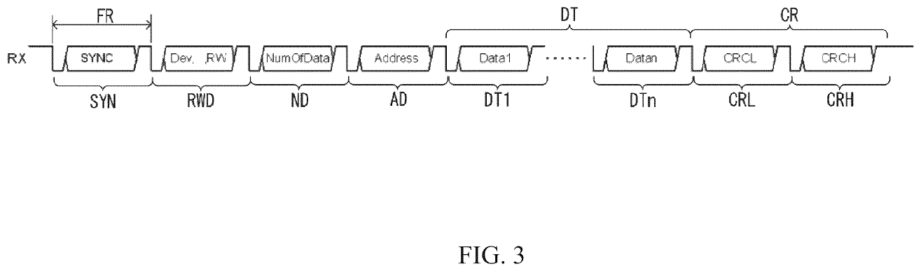

FIG. 3 is a diagram showing a format of a reception data RX during a Write process. In UART, communication is conducted using data units called frames. As shown in FIG. 3, a frame FR comprises bit data from a start bit S to a stop bit P. The start bit S is at a low level, and the stop bit P is at a high level. Between the start bit S and the stop bit P, a predetermined number of bits of bit data are arranged. For example, if 8 bits of bit data are arranged, the frame FR comprises 10 bits of bit data.

As shown in FIG. 3, the reception data RX comprises, in order from the beginning, a synchronization frame SYN, a Read/Write, etc. frame RWD, a data number frame ND, a register address frame AD, a Write data DT, and a CRC (Cyclic Redundancy Check) data CR.

The synchronization frame SYN is bit data for setting a baud rate in the semiconductor device 1.

The Read/Write, etc. frame RWD includes a device address and a Read/Write bit. The device address is bit data indicating an address of a target device (semiconductor device 1) (for example, 5 bits of data). The Read/Write bit is bit data indicating Read or Write (1 bit).

The data number frame ND is bit data indicating a number of frames included in the Write data DT.

The register address frame AD is bit data indicating an address in a register of the semiconductor device 1. The Write data DT comprises data frames DR1 to DTn (n is an integer of 1 or more).

The CRC data CR is bit data indicating an error detection code added with the frames RWD, ND, AD, and the Write data DT as error detection targets. The CRC data CR comprises a lower CRC frame CRL and a higher CRC frame CRH.

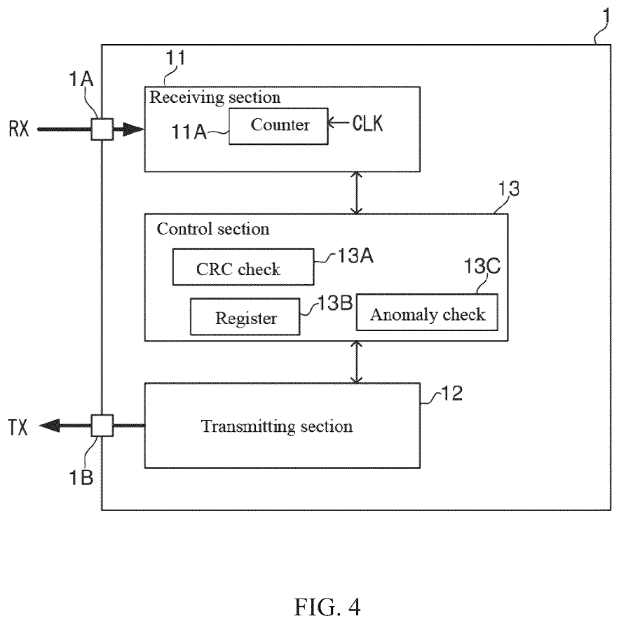

FIG. 4 is a diagram showing a configuration related to communication control in the semiconductor device 1. Furthermore, in FIG. 4, configurations other than those related to communication control are omitted. For example, if the semiconductor device 1 is an LED driver IC, the semiconductor device 1 comprises configurations related to LED driving, etc.

The semiconductor device 1 comprises a receiving section 11, a transmitting section 12, and a control section 13. The receiving section 11 receives a reception data RX via an RX terminal 1A and performs reception processing. The receiving section 11 comprises a counter 11A that counts a clock CLK. The counter 11A is used for setting a baud rate using a synchronization frame SYN, etc.

The control section 13 comprises a CRC check section 13A and a register 13B. The CRC check section 13A performs error detection using a CRC data CR. The register 13B can store various data, and data can be written to the register 13B, or data can be read from the register 13B.

The transmitting section 12 transmits a transmission data TX via a TX terminal 1B.

Furthermore, an anomaly check section 13C included in the control section 13 is described below.

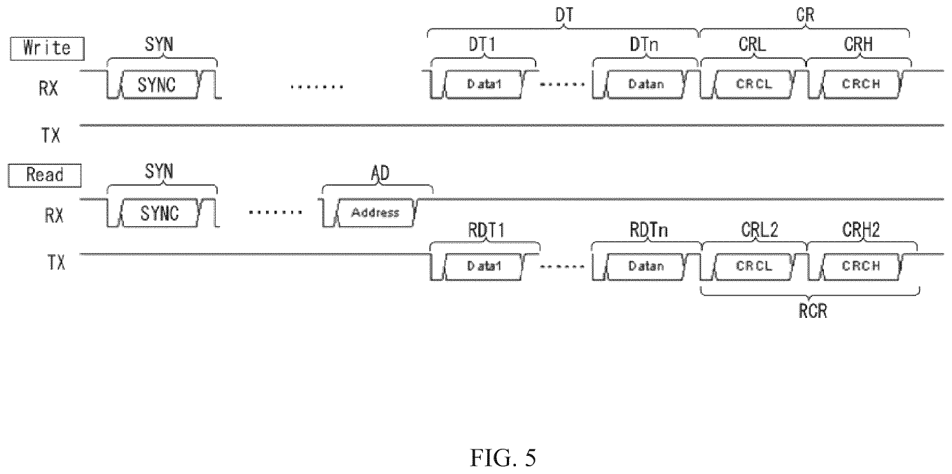

An upper part of FIG. 5 shows a reception data RX and a transmission data TX during a Write process. First, the synchronization frame SYN is transmitted by the reception data RX and received by the receiving section 11. In the receiving section 11, the clock CLK has a predetermined frequency (e.g., 48 MHZ), and the counter 11A counts the clock CLK for a predetermined number of bits (e.g., 8 bits) of data in the synchronization frame SYN. Then, a time for one bit, i.e., a baud rate (unit: bps) is obtained by the obtained count value. In the receiving section 11, the obtained baud rate is set, and sampling is performed for each bit from a frame next to the synchronization frame SYN onwards based on the set baud rate. As a result, a bit value (0 or 1) of bit data between a start bit S and a stop bit P in each frame is obtained.

Next, when an R/W, etc. frame is received by the receiving section 11, a bit value of bit data representing a device address, etc., between a start bit S and a stop bit P in the R/W, etc. frame RWD is obtained. At this time, a Read/Write bit represents Write.

Next, when a data number frame ND is received by the receiving section 11, a bit value of bit data representing a number of frames included in a Write data DT between a start bit S and a stop bit P in the data number frame ND is obtained.

Next, when a register address frame AD is received by the receiving section 11, a bit value of bit data representing a register address between a start bit S and a stop bit P in the register address frame AD is obtained.

Next, when data frames DT1 to DTn are received by the receiving section 11, a bit value of bit data representing a Write data between a start bit S and a stop bit P in each data frame DT1 to DTn is obtained.

Next, when a lower CRC frame CRL and a higher CRC frame CRH are received by the receiving section 11, a bit value of bit data representing an error detection data between a start bit S and a stop bit P in each CRC frame is obtained.

Then, based on the error detection data obtained above, error detection processing using CRC is performed by the CRC check section 13A. If no error is detected, the control section 13 writes the Write data obtained above to the register address obtained above in the register 13B.

As a result, the Write process is completed. In a case of the Write process, the transmission data TX is at a fixed level and is not transmitted.

A lower part of FIG. 5 shows a reception data RX and a transmission data TX during a Read process. In a case of the Read process, first, the synchronization frame SYN is received by the receiving section 11, and the baud rate is set. Next, the R/W, etc. frame RWD is received by the receiving section 11, and a device address and an R/W bit, etc., are obtained. At this time, the R/W bit represents Read.

Next, when the register address frame AD is received by the receiving section 11, the register address is obtained. Furthermore, during the Read process, the data number frame ND, the Write data DT, and the CRC data CR are not included in the reception data RX.

Then, the transmitting section 12 reads the data from the register address obtained above in the register 13B, adds a start bit and a stop bit to the read data, and transmits data frames RDT1 to RDTn (n is an integer of 1 or more) as a transmission data TX.

Next, the transmitting section 12 transmits a CRC data RCR, which is added to the Read data RDT comprising the data frames RDT1 to RDTn, as the transmission data TX. The CRC data RCR comprises a lower CRC frame CRL2 and a higher CRC frame CRH2. As a result, the Read process is completed.

### 3. ANOMALY CHECK

Next, checks for various anomalies performed by the anomaly check section 13C are illustrated. Anomalies detected by the anomaly check section 13C are anomalies whose cause can be identified. Furthermore, the cause of the anomalies cannot be identified by the CRC check.

### First Embodiment (Noise Check)

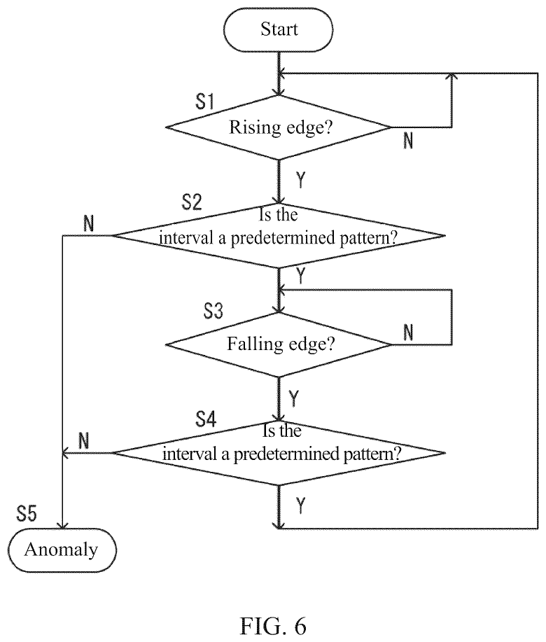

FIG. 6 is a diagram showing a flowchart related to an anomaly check process according to a first embodiment. In this embodiment, anomalies caused by environmental noise can be detected. Anomalies occur in the reception data RX in a wiring that transmits the reception data RX between the MCU 20 and the semiconductor device 1 due to environmental noise.

The process in FIG. 6 is performed on a frame of the reception data RX. Furthermore, this frame may be any frame.

When a falling edge occurs in the reception data RX and a start bit S in the frame is detected, a process in FIG. 6 begins. First, in step S1, it is checked whether there is a rising edge in the reception data RX; if there is no rising edge (N in step S1), the process returns to step S1, and if a rising edge occurs (Y in step S1), the process proceeds to step S2.

Herein, it is checked whether a time interval between a most recent falling edge and a current rising edge corresponds to a time interval of a possible predetermined pattern. For example, if 8 bits of data are arranged between a start bit S and a stop bit P, when a falling edge occurs at the start bit S, the next rising timing is at any of the 1st to 8th bits or at the stop bit P, and a pattern of the time interval corresponding to each of these becomes the above predetermined pattern. Furthermore, a time for one bit is determined by the baud rate. Additionally, allowable errors may be taken into consideration to determine whether the time interval corresponds to the predetermined pattern.

If the time interval does not correspond to the predetermined pattern (N in step S2), the process proceeds to step S5, and it is determined that an anomaly has occurred. On the other hand, if the time interval corresponds to the predetermined pattern (Y in step S2), the process proceeds to step S3, where it is checked whether there is a falling edge in the reception data RX, if there is no falling edge (N in step S3), the process returns to step S3, and if a falling edge occurs (Y in step S3), the process proceeds to step S4.

Herein, it is checked whether the time interval between the most recent rising edge and the current falling edge corresponds to a time interval of a possible predetermined pattern. For example, if 8 bits of data are arranged between the start bit S and the stop bit P, when a rising edge occurs at the 1st bit, the next falling timing is at any of the 2nd to 8th bits, and a pattern of the time interval corresponding to each of these becomes the above predetermined pattern.

If the time interval does not correspond to the predetermined pattern (N in step S4), the process proceeds to step S5, and it is determined that an anomaly has occurred. On the other hand, if the time interval corresponds to the predetermined pattern (Y in step S4), the process returns to step S1.

During the process in FIG. 6, if the predetermined time from the start bit S to the last bit between the start bit S and the stop bit P has elapsed, it is determined to be normal, and the process is completed.

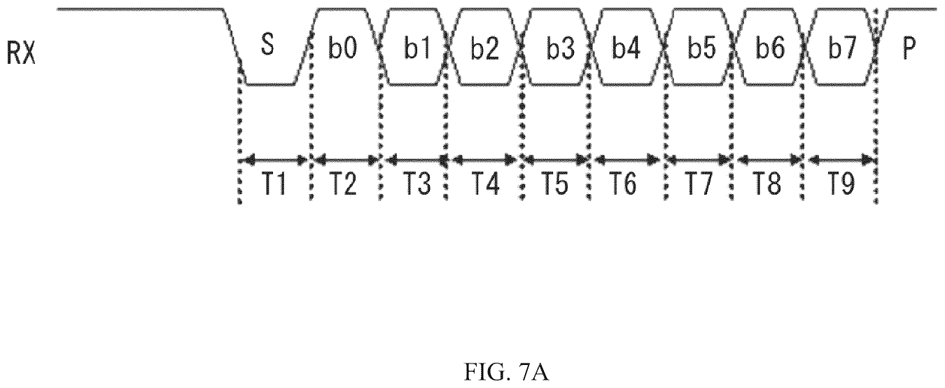

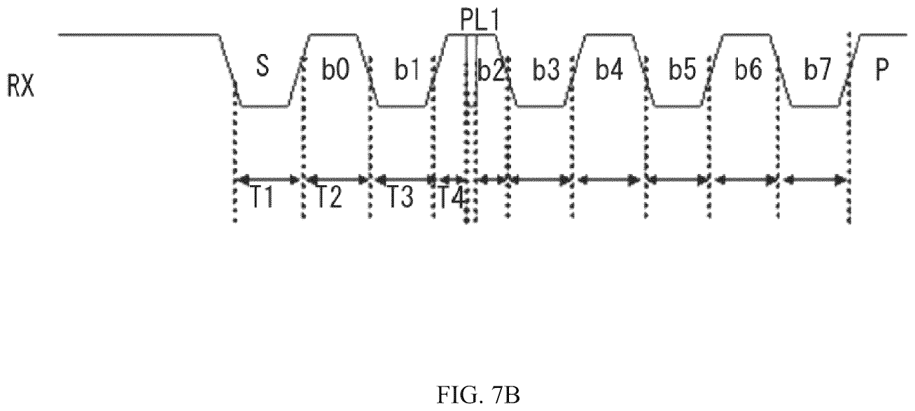

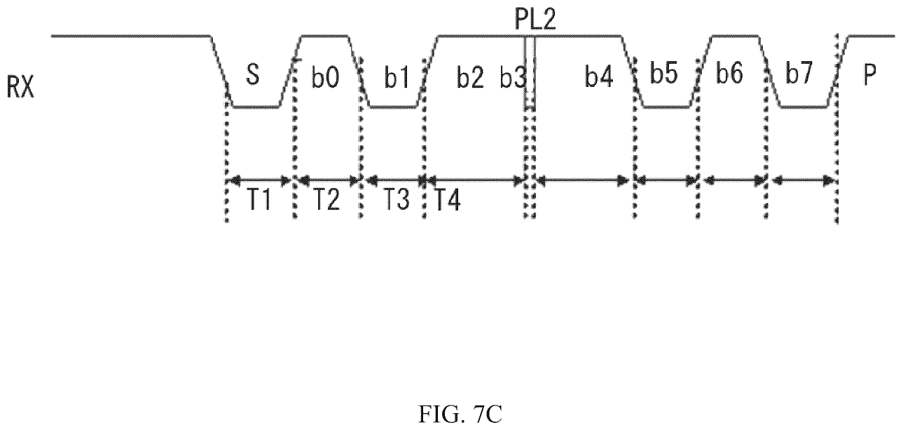

Herein, the process in FIG. 6 is illustrated using examples in FIGS. 7A to 7C. FIG. 7A shows a case where the reception data RX is normal. In this case, since falling edges and rising edges appear alternately from the start bit S to the stop bit P, time intervals T1 to T9 between adjacent rising edges and falling edges each correspond to the predetermined pattern, and it is determined to be normal.

FIG. 7B shows a case where a short falling pulse PL1 due to noise occurs in the middle of a 3rd bit (b2) between a start bit S and a stop bit P in the reception data RX. In this case, time intervals T1 to T3 corresponding to the start bit S, a 1st bit b0, and a 2nd bit b1 correspond to the predetermined pattern, but a time interval T4 from a rising edge of the 3rd bit b2 to a falling edge due to the pulse PL1 does not correspond to the predetermined pattern (N in step S4), and it is determined to be anomalous (step S5).

FIG. 7C shows a case where a short falling pulse PL2 due to noise occurs in the middle of a 4th bit (b3) between a start bit S and a stop bit P in the reception data RX. In this case, time intervals T1 to T3 corresponding to a start bit S, a 1st bit b0, and a 2nd bit b1 correspond to the predetermined pattern, but a time interval T4 from a rising edge of a 3rd bit b2 to a falling edge due to the pulse PL2 does not correspond to the predetermined pattern (N in step S4), and it is determined to be anomalous (step S5).

Furthermore, when a short rising pulse occurs due to noise, a time interval from the falling edge to a rising edge no longer corresponds to the predetermined pattern (N in step S2), and it is determined to be anomalous (step S5).

### Second Embodiment (Conflict Check)

Next, a second embodiment is illustrated. In this embodiment, anomalies caused by anomalies of the MCU 20 (software anomalies) can be detected. Specifically, it is determined whether the reception data RX is anomalously received during a transmission of the transmission data TX during the Read process.

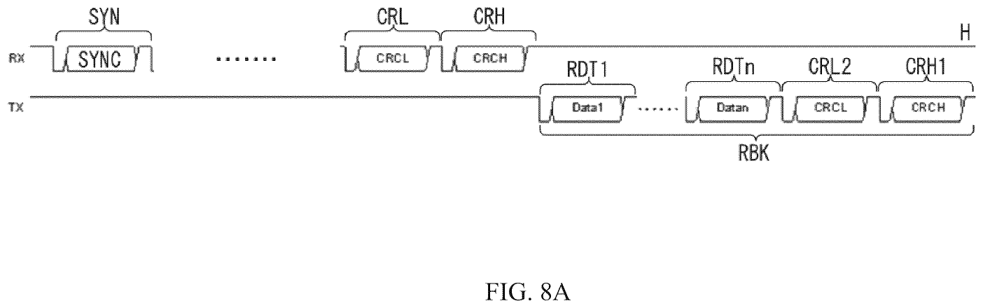

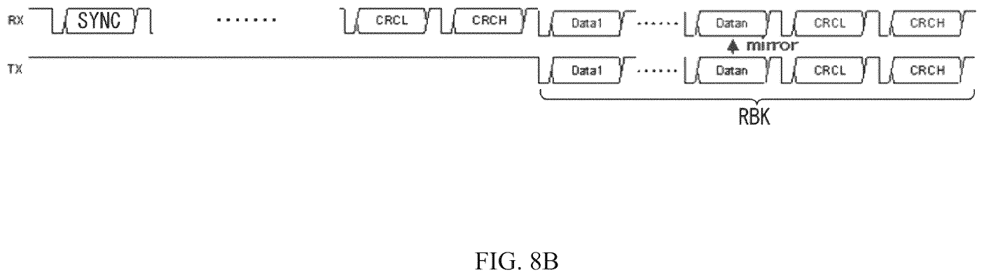

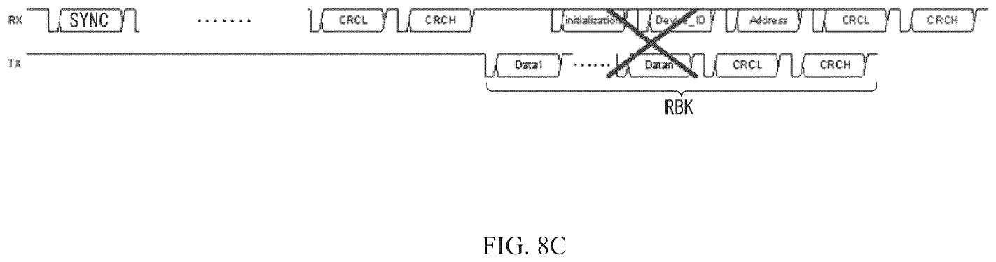

First, an anomaly check according to this embodiment in the communication system 501 shown in FIG. 1 is illustrated. FIG. 8A is a diagram showing a normal state during the Read process in the communication system 501. In a case of the Read process, after the reception data RX is received by the receiving section 11 from the synchronization frame SYN to the CRC frames CRL, CRH, data frames RDT1 to RDTn and CRC frames CRL2, CRH2 are transmitted as readback data RBK by the transmitting section 12 using the transmission data TX. Herein, if normal, as shown in FIG. 8A, the reception data RX is fixed at a high level during a transmission of the readback data RBK. On the other hand, if anomalous, a low level is included in the reception data RX during the transmission of the readback data RBK. As such, in this embodiment, it is checked whether the reception data RX is fixed at a high level during the transmission of the readback data RBK, and it is determined whether it is normal.

Next, an anomaly check according to this embodiment in the communication system 502 shown in FIG. 2 is illustrated. FIG. 8B is a diagram showing a normal state during the Read process in the communication system 502. In a case of the Read process, the readback data RBK is transmitted by the transmission data TX, but mirroring of the readback data RBK to the reception data RX occurs by a CAN transceiver 40 provided in the communication system 502.

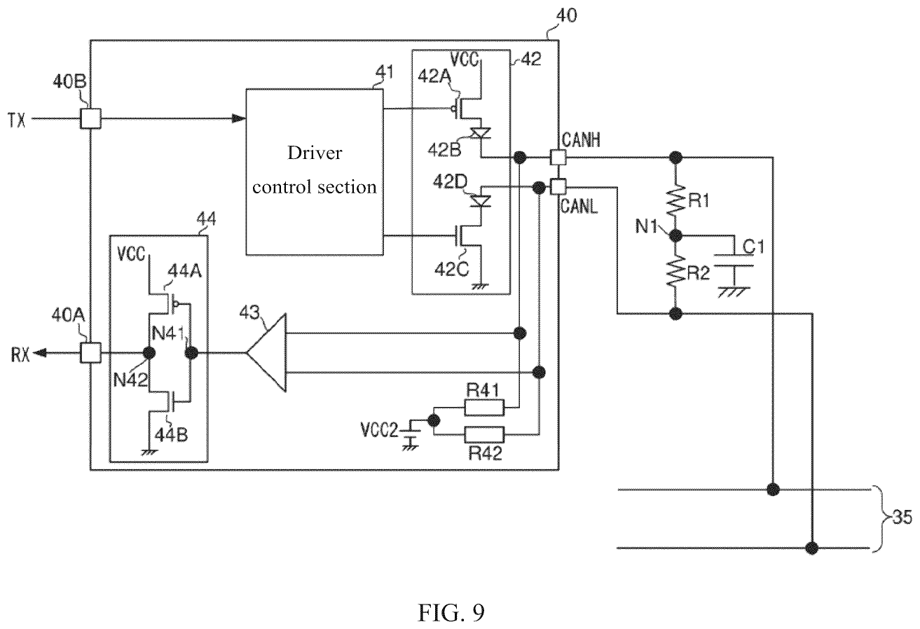

Herein, FIG. 9 is a diagram showing a configuration of the CAN transceiver 40. The CAN transceiver 40 comprises a driver control section 41, a driver 42, a receiver 43, and an output section 44. Additionally, the CAN transceiver 40 comprises a TXD terminal 40B, an RXD terminal 40A, a CANH terminal, and a CANL terminal.

The CANH terminal and the CANL terminal are each connected to respective lines of a CAN bus 35. Termination resistors R1, R2 are connected in series between the CANH terminal and the CANL terminal. Resistance values of the termination resistors are defined by ISO 11898, and each of the termination resistors R1, R2 comprises a 6052 resistor. One end of a capacitor C1 is connected to a connection node N1 where the resistors R1, R2 are connected to each other.

The driver 42 comprises a PMOS transistor (P-channel MOSFET (metal-oxide-semiconductor field-effect transistor)) 42A, a diode 42B, an NMOS transistor (N-channel MOSFET) 42C, and a diode 42D. A source of the PMOS transistor 42A is connected to an application terminal of a power supply voltage VCC. A drain of the PMOS transistor 42A is connected to an anode of the diode 42B. A cathode of the diode 42B is connected to the CANH terminal. A source of the NMOS transistor 42C is connected to a ground terminal. A drain of the NMOS transistor 42C is connected to a cathode of the diode 42D. An anode of the diode 42D is connected to the CANL terminal. The diodes 42B, 42D are used to prevent backflow during surge occurrence.

The driver control section 41 controls on/off of the PMOS transistor 42A and the NMOS transistor 42C based on the transmission data TX input from an outside via a TXD terminal.

More specifically, when the PMOS transistor 42A and the NMOS transistor 42C are in on states, a current flowing through the termination resistors R1, R2 is common, so voltage drops occurring in each of the termination resistors R1, R2 are the same, and a high-side signal CANH occurring at the CANH terminal is a voltage higher than a voltage of the connection node N1 (=midpoint voltage) by an amount of the voltage drop, and a low-side signal CANL occurring at the CANL terminal is a voltage lower than a voltage of the connection node N1 (=midpoint voltage) by the amount of the voltage drop. In this case, the high-side signal CANH is at a high level, and the low-side signal CANL is at a low level.

Herein, the CANH terminal and the CANL terminal are each connected to an application terminal of a power supply voltage VCC2 via resistors R41, R42. When the PMOS transistor 42A and the NMOS transistor 42C are set to off states, a voltage of the connection node N1 gradually approaches the second power supply voltage VCC2 due to the action of the resistors R41, R42, which have relatively high resistance values. The second power supply voltage VCC2 is a low level of the high-side signal CANH and a high level of the low-side signal CANL, and is the same voltage as the above intermediate voltage.

As such, the transmission data TX input to the TXD terminal is output to the CAN bus 35 from the CANH terminal and the CANL terminal.

On the other hand, the output section 44 comprises a PMOS transistor 44A and an NMOS transistor 44B. A source of the PMOS transistor 44A is connected to an application terminal of the power supply voltage VCC. A drain of the PMOS transistor 44A is connected to a drain of the NMOS transistor 44B at a node N42. A source of the NMOS transistor 44B is connected to the ground terminal. Each of a voltage at the CANH terminal and a voltage at the CANL terminal are input to the receiver 43. An output terminal of the receiver 43 is connected to a node N41, where a gate of the PMOS transistor 44A and a gate of the NMOS transistor 44B are connected. The node N42 is connected to an RXD terminal.

The receiver 43 applies a high-level or low-level signal to the node N41 according to a differential of an input voltage. Thus, the output section 44 outputs a signal that logically inverts an output of the receiver 43 as the reception data RX from the RXD terminal to the outside. As such, the data input from the CAN bus 35 is output from the RXD terminal.

When the high-side signal CANH is at a high level and the low-side signal CANL is at a low level, it is called “dominant,” and when the high-side signal CANH is at a low level and the low-side signal CANL is at a high level, it is called “recessive.” The dominant is prioritized over the recessive.

As shown in FIG. 8B, when the readback data RBK is being transmitted, if normal, there is no transmission from the MCU 20, and it is considered recessive on the CAN transceiver 30 side, so the readback data RBK can be transmitted to the CAN transceiver 30. At this time, the high-side signal CANH and the low-side signal CANL are input to the receiver 43 and output as the reception data RX from the output section 44. That is, the readback data RBK is mirrored as shown in FIG. 8B and becomes the reception data RX.

On the other hand, there are situations wherein, due to an anomaly in the MCU 20, as shown in an example of FIG. 8C, the MCU 20 performs the next transmission while transmitting the readback data RBK. In this case, the readback data RBK and the reception data RX are mixed, causing the reception data RX to differ from the mirrored readback data RBK. This is because when the high-side signal CANH and the low-side signal CANL based on the transmission data TX are recessive, the CAN transceiver 30 side may become dominant.

As such, in this embodiment, it is checked whether the reception data RX is the mirrored data of the readback data RBK during the transmission of the readback data RBK, and it is determined whether it is normal.

### Third Embodiment (Synchronous Frame Pattern Check)

Next, a third embodiment is illustrated. In this embodiment, anomalies caused by anomalies in the MCU 20 (software anomalies) can be detected. Specifically, the synchronous frame SYN in the reception data RX is a pattern that alternates between a high level and a low level from the low level of the start bit S, and anomalies related to this pattern are detected.

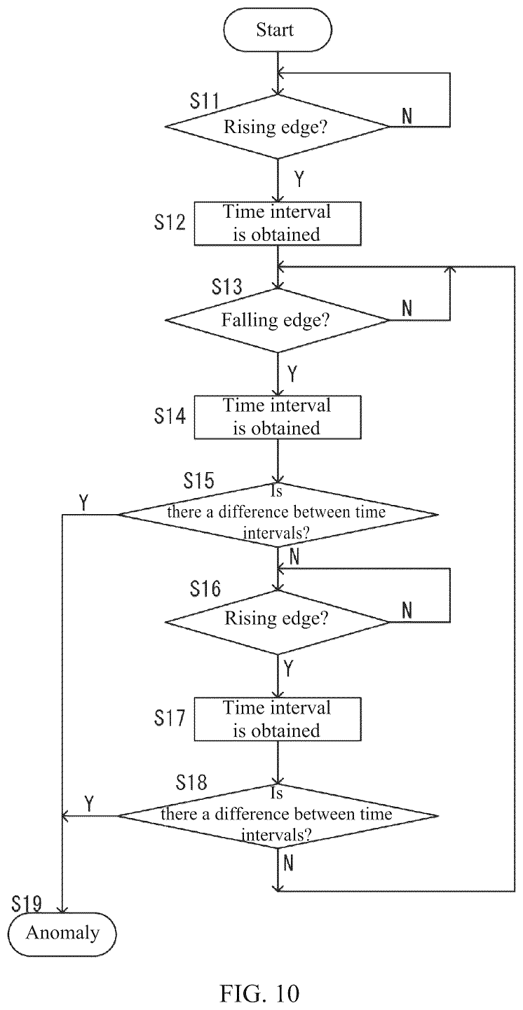

FIG. 10 is a flowchart related to anomaly checks according to this embodiment. When a falling edge (i.e., start bit S) in the synchronous frame SYN is detected, a process in FIG. 10 begins. First, in step S11, it is checked whether there is a rising edge in the reception data RX, and if there is no rising edge (N in step S11), it returns to step S11. If a rising edge occurs (Y in step S11), a time interval from the most recent falling edge to the current rising edge is obtained in step S12.

Next, in step S13, it is confirmed whether there is a falling edge in the reception data RX, and if there is no falling edge (N in step S13), it returns to step S13. If a falling edge occurs (Y in step S13), a time interval from the most recent rising edge to the current falling edge is obtained in step S14. Then, in step S15, it is confirmed whether there is a difference between a time interval obtained in step S12 and a time interval obtained in step S14. If there is a difference (Y in step S15), it proceeds to step S19 and is determined to be anomalous.

On the other hand, if there is no difference (N in step S15), it is confirmed in step S16 whether there is a rising edge in the reception data RX, and if there is no rising edge (N in step S16), it returns to step S16. If a rising edge occurs (Y in step S16), a time interval from the most recent falling edge to the current rising edge is obtained in step S17. Then, in step S18, it is confirmed whether there is a difference between a time interval obtained in step S14 and a time interval obtained in step S17. If there is a difference (Y in step S18), it proceeds to step S19 and is determined to be anomalous.

On the other hand, if there is no difference (N in step S18), it returns to step S13, and it is confirmed whether there is a falling edge in the reception data RX, and if there is a falling edge, a time interval is obtained in step S14, and in step S15, it is confirmed whether there is a difference between a time interval obtained in step S17 and a time interval obtained in step S14. Subsequently, the operation is the same as previously described.

During a process in FIG. 10, if a rising edge due to the stop bit P is detected and there is no difference between the time intervals, it is determined to be normal. Furthermore, the above confirmation of whether there is a difference between the time intervals may consider allowable errors. That is, even if there is a difference between the time intervals, it may be considered that there is no difference if it is within the allowable errors.

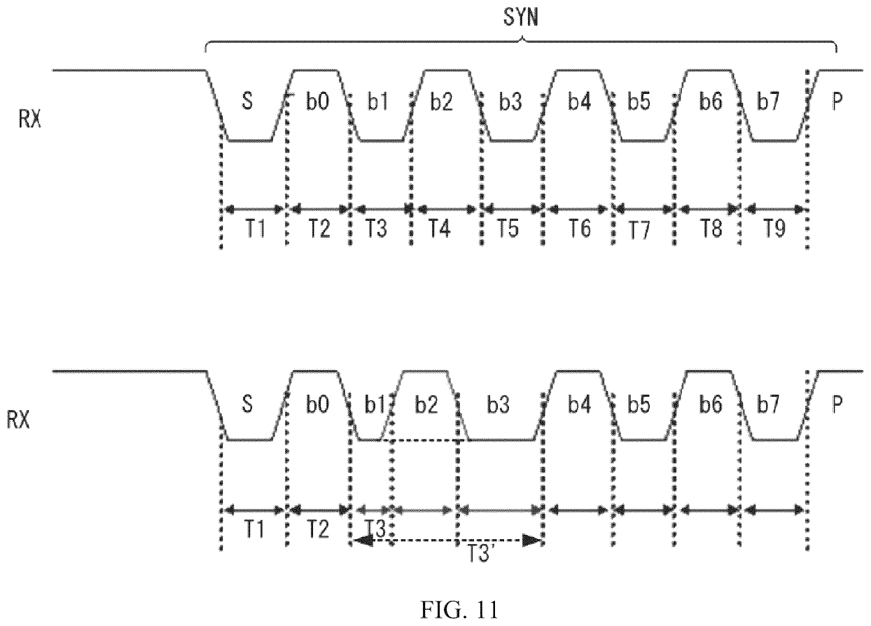

The upper part of FIG. 11 shows an example of a synchronous frame SYN in a normal case. In this case, it is confirmed that there is no difference between adjacent time intervals for each time intervals T1 to T9 from the start bit S to the last bit b7 between the start bit S and the stop bit P, so it is determined to be normal.

On the other hand, the lower part of FIG. 11 shows an example of a synchronous frame SYN in an anomalous case. Specifically, a bit b2 is temporally shifted forward due to jitter. As a result, a difference occurs between time intervals T2 and T3 (Y in step S18), and it is determined to be anomalous (step S19).

Additionally, in the lower part of FIG. 11, if the bit b2, which should be at a high level in a normal synchronous frame SYN as shown by a broken line, is at a low level due to an anomaly, a difference occurs between the time interval T2 and a time interval T3′ from a falling edge to a rising edge of the reception data RX (Y in step S18), and it is determined to be anomalous (step S19).

Additionally, for example, as shown in FIG. 8C, if there is transmission by the MCU 20 during the Read process while transmitting the readback data RBK, and the frame in the reception data RX after the last frame of the readback data RBK (higher CRC frame CRH2) is misrecognized as a synchronous frame SYN, the anomaly can also be detected by the anomaly check according to this embodiment. This is because in the misrecognized frame, levels do not necessarily change for each bit as in the case of the synchronous frame SYN.

### Fourth Embodiment (Synchronous Frame Stability Check)

Next, a fourth embodiment is illustrated. In this embodiment, anomalies caused by anomalies in the MCU 20 (software anomalies) can be detected. Specifically, it is confirmed whether a baud rate of the synchronous frame SYN is stable.

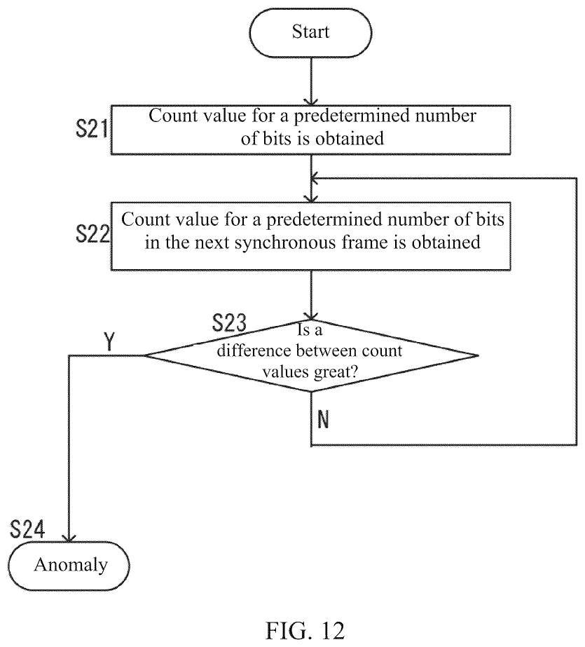

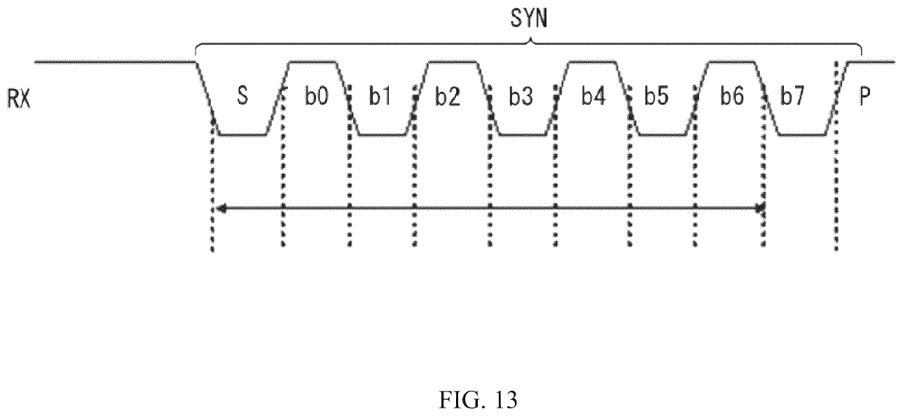

FIG. 12 is a flowchart related to an anomaly check according to this embodiment. When a process in FIG. 12 begins, first, in step S21, a count value (a value counted by a clock CLK) by a counter 11A for a predetermined number of bits in a synchronous frame SYN is obtained and stored. Herein, the count value obtained by counting a predetermined number of bits (for example, 8 bits) is used to set a baud rate using the synchronous frame SYN. In an example of FIG. 13, a count value for 8 bits from a start bit S to a bit b6 in the synchronous frame SYN is obtained.

Next, in step S22, the count value by the counter 11A for a predetermined number of bits in the next synchronous frame SYN is obtained and stored. Then, in step S23, it is checked whether a difference between a count value obtained in step S21 and a count value obtained in step S22 is equal to or greater than a threshold value, and if it is equal to or greater than the threshold value (Y in step S23), it is determined to be anomalous (step S24).

On the other hand, if it is less than the threshold value (N in step S23), the process returns to step S22, and a count value for the next synchronous frame SYN is obtained and stored. Then, in step S23, it is checked whether a difference between the count value obtained in the previous step S22 and a count value obtained in the current step S22 is equal to or greater than the threshold value, and if it is equal to or greater than the threshold value (Y in step S23), it is determined to be anomalous (step S24). On the other hand, if it is less than the threshold value (N in step S23), the process returns to step S22.

According to such processing, by checking the difference in count values between the previous and current synchronous frames SYN, a stability of the baud rate of the synchronous frame SYN is checked. Particularly, when storing the count value, since the older count value can be overwritten, the storage area can be small.

Furthermore, count values obtained in steps S21, S22 can be sequentially stored and accumulated, and in step S23, a difference between a maximum value and a minimum value of count values currently stored may be checked.

### 4. VEHICLE

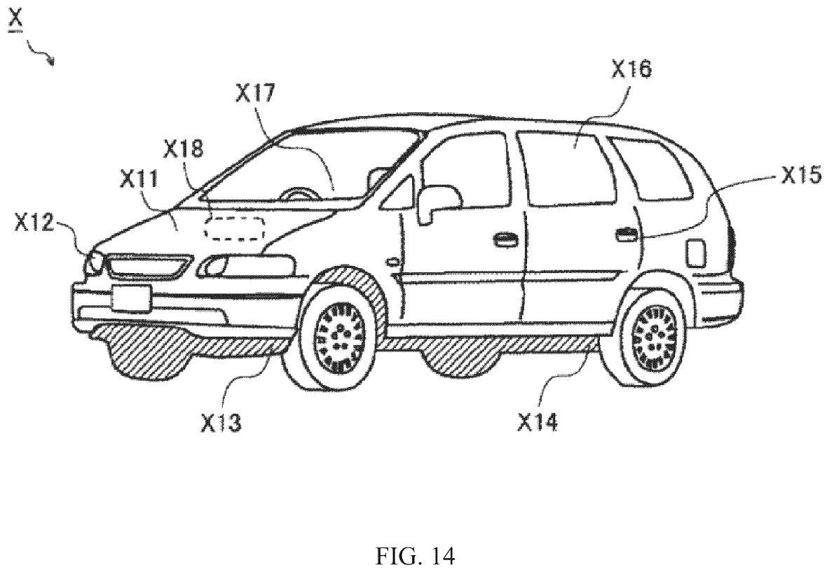

FIG. 14 is an external view showing an example configuration of a vehicle X. In this configuration example, the vehicle X is equipped with various electronic equipment X11 to X18 that operate by receiving power supply from an unillustrated battery. Furthermore, the mounting positions of the electronic equipment X11 to X18 in FIG. 14 may differ from actual positions for convenience of illustration.

The electronic equipment X11 is an engine control unit that performs control related to the engine (injection control, electronic throttle control, idling control, oxygen sensor heater control, auto cruise control, etc.).

The electronic equipment X12 is a lamp control unit that performs control of turning on and off lights of HID [high intensity discharged lamp], DRL [daytime running lamp], etc.

The electronic equipment X13 is a transmission control unit that performs control related to a transmission.

The electronic equipment X14 is a body control unit that performs control related to a movement of the vehicle X (ABS [anti-lock brake system] control, EPS [electric power steering] control, electronic suspension control, etc.).

The electronic equipment X15 is a security control unit that performs drive control of door locks, security alarms, etc.

The electronic equipment X16 is electronic equipment that is installed in the vehicle X at a time of shipment from a factory as standard equipment or manufacturer option, such as wipers, electric door mirrors, power windows, dampers (shock absorbers), electric sunroofs, electric seats, etc.

The electronic equipment X17 is electronic equipment that is arbitrarily installed in the vehicle X as user options, such as in-vehicle A/V [audio/visual] equipment, a car navigation system, an ETC [electronic toll collection system], etc.

The electronic equipment X18 is electronic equipment that comprises a high-voltage motor, such as an in-vehicle blower, an oil pump, a water pump, a battery cooling fan, etc.

Furthermore, a communication system including the aforementioned MCU 20 and semiconductor device 1 can be applied to any of the electronic equipment X11 to X18.

### 5. OTHER

Furthermore, in addition to the above embodiments, the various technical features disclosed in this specification can be modified in various ways without departing from the spirit of the technical creation. That is, the above embodiments should be considered in all respects as illustrative and not restrictive, and the technical scope of the present disclosure should not be limited to the above embodiments but should be understood to include all modifications that fall within the meaning and scope of the claims and equivalents.

### 6. APPENDIX

As described above, a semiconductor device (1) according to one aspect of the present disclosure is configured to comprise:
a receiving section (11) configured to a receive reception data (RX) as serial data from an outside, and
an anomaly check section (13C) configured to check for a presence or absence of an anomaly, whose cause can be identified, by checking the reception data (first configuration).

According to such a configuration, anomalies in serial communication can be identified.

Furthermore, the first configuration may be configured so that the cause is environmental noise (second configuration).

Furthermore, the second configuration may be configured so that the anomaly check section checks whether a time interval from a falling edge to a rising edge, or a time interval from a rising edge to a falling edge, in the reception data corresponds to a possible predetermined pattern (third configuration).

Furthermore, the first configuration may be configured so that the cause is an anomaly in a transmitting device (20) configured to transmit the serial data (fourth configuration).

Furthermore, the fourth configuration may be configured to comprise a transmitting section (12),
wherein the anomaly check section checks, in a case of a Read process, whether the reception data is at a fixed level while a readback data (RBK) is being transmitted from the transmitting section after the reception data is received (fifth configuration).

Furthermore, the fourth configuration may be configured to comprise a transmitting section (12),
wherein the anomaly check section checks, in a case of a Read process, whether the reception data mirrors a readback data (RBK) while the readback data is being transmitted from the transmitting section after the reception data is received (sixth configuration).

Furthermore, the fourth configuration may be configured so that the anomaly check section checks whether there is a difference between a time interval from a falling edge to a rising edge and a time interval from a rising edge to a falling edge in a synchronization frame (SYN) as the reception data (seventh configuration).

Furthermore, the fourth configuration may be configured to comprise a counter (11A) configured to count a clock (CLK),
wherein the anomaly check section obtains a count value from the counter corresponding to a predetermined number of bits in a synchronization frame as the reception data and checks for changes in the count value in different synchronization frames (eighth configuration).

Furthermore, the eighth configuration may be configured so that the anomaly check section stores previous and current count values and checks a difference between the previous and current count values (ninth configuration).

Furthermore, the eighth configuration may be configured so that the anomaly check section sequentially stores and accumulates count values and checks a difference between a maximum value and a minimum value among the stored count values (tenth configuration).

Furthermore, one aspect of the present disclosure comprises the semiconductor device of any of the first to tenth configurations and a transmitting device configured to transmit the reception data (eleventh configuration).

Furthermore, the eleventh configuration may be configured for in-vehicle use (twelfth configuration).

### INDUSTRIAL APPLICABILITY

The present disclosure can be utilized, for example, in communication systems for various applications.

1. A semiconductor device, comprising:
a receiving section configured to receive a reception data as serial data from an outside; and
an anomaly check section configured to check for a presence or absence of an anomaly, whose cause can be identified, by checking the reception data.

2. The semiconductor device of claim 1, wherein the cause is environmental noise.

3. The semiconductor device of claim 2, wherein the anomaly check section checks whether a time interval from a falling edge to a rising edge, or a time interval from a rising edge to a falling edge, in the reception data corresponds to a possible predetermined pattern.

4. The semiconductor device of claim 1, wherein the cause is an anomaly in a transmission device configured to transmit the serial data.

5. The semiconductor device of claim 4, comprising a transmitting section,
wherein the anomaly check section checks, in a case of a Read process, whether the reception data is at a fixed level while a readback data is being transmitted from the transmitting section after the reception data is received.

6. The semiconductor device of claim 4, comprising a transmitting section,
wherein the anomaly check section checks, in a case of a Read process, whether the reception data mirrors a readback data while the readback data is being transmitted from the transmitting section after the reception data is received.

7. The semiconductor device of claim 4, wherein the anomaly check section checks whether there is a difference between a time interval from a falling edge to a rising edge and a time interval from a rising edge to a falling edge in a synchronization frame as the reception data.

8. The semiconductor device of claim 4, comprising a counter configured to count a clock,
wherein the anomaly check section obtains a count value from the counter corresponding to a predetermined number of bits in a synchronization frame as the reception data and checks for changes in the count value in different synchronization frames.

9. The semiconductor device of claim 8, wherein the anomaly check section stores previous and current count values and checks a difference between the previous and current count values.

10. The semiconductor device of claim 8, wherein the anomaly check section sequentially stores and accumulates count values and checks a difference between a maximum value and a minimum value among the stored count values.

11. A communication system, comprising the semiconductor device of claim 1, and a transmitting device configured to transmit the reception data.

12. The communication system of claim 11, wherein it is for in-vehicle use.
